(19) United States
(12) Patent Application Publication
(10) Pub. No.: US 2016/0111794 A1
(43) Pub. Date: Apr. 21, 2016

(54) ANTENNA SYSTEM

(71) Applicant: Acer Incorporated, New Taipei City (TW)

(72) Inventor: Chung-Wen YANG, New Taipei City (TW)

(21) Appl. No.: 14/603,621

(22) Filed: Jan. 23, 2015

(30) Foreign Application Priority Data
Oct. 15, 2014 (TW) 103135622

(51) Int. Cl. H01Q 21/28; H01Q 9/04; H01Q 5/20; H01Q 1/50

(52) U.S. Cl. CPC H01Q 21/28; H01Q 1/50; H01Q 9/04; H01Q 5/20

(57) ABSTRACT

An antenna system includes a first antenna and a second antenna. The first antenna includes a first feeding element and a first radiation element. The first feeding element is coupled to a first signal source. A first end of the first radiation element is coupled to a ground region, and a second end of the first radiation element is open and adjacent to the first feeding element. The second antenna includes a second feeding element and a second radiation element. The second feeding element is coupled to a second signal source. A first end of the second radiation element is coupled to the ground region, and a second end of the second radiation element is open and adjacent to the second feeding element.

### CROSS REFERENCE TO RELATED APPLICATIONS

This Application claims priority of Taiwan Patent Application No. 103135622 filed on Oct. 15, 2014, the entirety of which is incorporated by reference herein.

### BACKGROUND OF THE INVENTION

1. Field of the Invention

The disclosure generally relates to an antenna system, and more particularly, to an antenna system for improving isolation.

2. Description of the Related Art

With advancement in mobile communication technology, mobile devices such as portable computers, mobile phones, multimedia players, and other hybrid functional portable electronic devices have become more common. To satisfy user demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi and Bluetooth systems and using frequency bands of 2.4 GHz, 5.2 GHz, and 5.8 GHz.

An antenna system is indispensable in a mobile device supporting wireless communication. However, since the interior space of a mobile device is very limited, multiple antennas are usually disposed close to each other, and such a design causes serious interference between antennas. As a result, there is a need to design a new antenna system for solving the problem of bad isolation in a conventional antenna system.

### BRIEF SUMMARY OF THE INVENTION

In a preferred embodiment, the invention is directed to an antenna system, including: a first antenna, including a first feeding element and a first radiation element, wherein the first feeding element is coupled to a first signal source, a first end of the first radiation element is coupled to a ground region, and a second end of the first radiation element is open and adjacent to the first feeding element; and a second antenna, including a second feeding element and a second radiation element, wherein the second feeding element is coupled to a second signal source, a first end of the second radiation element is coupled to the ground region, and a second end of the second radiation element is open and adjacent to the second feeding element.

In some embodiments, the first antenna and the second antenna are both coupling-feed antennas, the first radiation element is excited by the first feeding element through mutual coupling, and the second radiation element is excited by the second feeding element through mutual coupling. In some embodiments, the coupling-feed antennas are configured to improve isolation and SAR (Specific Absorption Rate) of the antenna system. In some embodiments, the second end of the first radiation element and the second end of the second radiation element extend away from each other. In some embodiments, the first radiation element and the second radiation element each have an L-shape. In some embodiments, the first antenna further includes a first additional branch, the second antenna further includes a second additional branch, and the first additional branch and the second additional branch extend away from each other. In some embodiments, the first additional branch and the second additional branch each have a straight-line shape. In some embodiments, a combination of the first radiation element and the first additional branch, and a combination of the second radiation element and the second additional branch each have an F-shape. In some embodiments, the second end of the first radiation element and the second end of the second radiation element extend toward each other. In some embodiments, the first antenna and the second antenna both operate in a first frequency band and a second frequency band, the first frequency band is substantially from 2400 MHz to 2500 MHz, and the second frequency band is substantially from 5150 MHz to 5850 MHz.

### BRIEF DESCRIPTION OF DRAWINGS

The invention can be more fully understood by reading the subsequent detailed description and examples with references made to the accompanying drawings, wherein:

FIG. 1 is a diagram of an antenna system according to an embodiment of the invention;

FIG. 2 is a diagram of an antenna system according to an embodiment of the invention;

FIG. 3 is a diagram of an antenna system according to an embodiment of the invention;

FIG. 4 is a diagram of isolation of a PIFA (Planar Inverted F Antenna) system; and

FIG. 5 is a diagram of isolation of an antenna system according to an embodiment of the invention.

### DETAILED DESCRIPTION OF THE INVENTION

In order to illustrate the foregoing and other purposes, features and advantages of the invention, the embodiments and figures of the invention will be described in detail as follows.

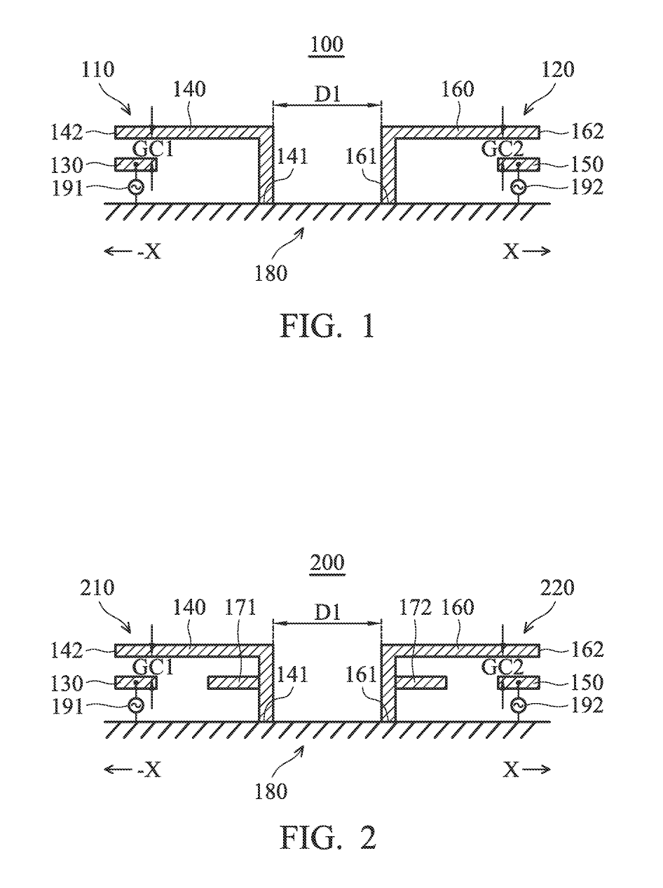

FIG. 1 is a diagram of an antenna system 100 according to an embodiment of the invention. The antenna system 100 may be applied in a mobile device, such as a smartphone, a tablet computer, or a notebook computer. As shown in FIG. 1, the antenna system 100 includes a first antenna 110 and a second antenna 120. The first antenna 110 includes a first feeding element 130 and a first radiation element 140. The first feeding element 130 is coupled to a first signal source 191. The first feeding element 130 may substantially have a rectangular shape or a square shape. The first signal source 191 may be an RF (Radio Frequency) module for exciting the first antenna 110. The first radiation element 140 may substantially have an L-shape. A first end 141 of the first radiation element 140 is coupled to a ground region 180, and a second end 142 of the first radiation element 140 is open and adjacent to the first feeding element 130. A first coupling gap GC1 may be formed between the second end 142 of the first radiation element 140 and the first feeding element 130, and the width of the first coupling gap GC1 may be smaller than 2 mm. The ground region 180 may be a ground metal plane of a mobile device, and it may be used to provide a ground voltage. The second antenna 120 includes a second feeding element 150 and a second radiation element 160. The second feeding element 150 is coupled to a second signal source 192. The second feeding element 150 may substantially have a rectangular shape or a square shape. The second signal source 192 may be an RF module for exciting the second antenna 120. The second radiation element 160 may substantially have an L-shape. A first end 161 of the second radiation element 160 is coupled to the ground region 180, and a second end 162 of the second radiation element 160 is open and adjacent to the second feeding element 150. A second coupling gap GC2 may be formed between the second end 162 of the second radiation element 160 and the second feeding element 150, and the width of the second coupling gap GC2 may be smaller than 2 mm. The second end 142 of the first radiation element 140 and the second end 162 of the second radiation element 160 may extend away from each other. For example, the second end 142 of the first radiation element 140 may extend toward the −X axis, and the second end 162 of the second radiation element 160 may extend toward the +X axis, such that they may extend away from each other.

As to antenna theory, the first antenna 110 and the second antenna 120 of the antenna system 100 are both coupling-feed antennas. The first radiation element 140 is excited by the first feeding element 130 through mutual coupling, and the second radiation element 160 is excited by the second feeding element 150 through mutual coupling. The aforementioned coupling-feed antennas are configured to improve the isolation and SAR (Specific Absorption Rate) of the antenna system 100. More particularly, the first antenna 110 and the second antenna 120 both operate in a low-frequency band and a high-frequency band. For the first antenna 110, the high-frequency band is generated by exciting the first feeding element 130, and the low-frequency band is generated by exciting the first feeding element 130 and the first radiation element 140. For the second antenna 120, the high-frequency band is generated by exciting the second feeding element 150, and the low-frequency band is generated by exciting the second feeding element 150 and the second radiation element 160. For a conventional 2.4 GHz/5 GHz dual-band PIFA (Planar Inverted F Antenna), its low-frequency resonant paths may generate higher-order resonant modes and contribute to high-frequency currents, and therefore the high-frequency (5 GHz) SAR of the conventional PIFA may not meet the legal requirements. In the invention, since the first feeding element 130 is separate from the first radiation element 140 and the second feeding element 150 is separate from the second radiation element 160, with such a design, the low-frequency resonant paths do not tend to generate higher-order resonant modes which directly affect the antenna performance in the high-frequency band, and the high-frequency SAR of the antenna system 100 is greatly reduced accordingly. In addition, the first antenna 110 and the second antenna 120 of the invention extend in opposite directions, with their open ends away from each other, such that the isolation of the antenna system 100 is improved more. Therefore, the antenna system 100 of the invention can keep the isolation between the first antenna 110 and the second antenna 120 within an acceptable range (e.g., −15 dB or better) even if there is no additional isolation element arranged in the antenna system 100.

FIG. 2 is a diagram of an antenna system 200 according to an embodiment of the invention. FIG. 2 is similar to FIG. 1. The difference between the two embodiments is that a first antenna 210 of the antenna system 200 further includes a first additional branch 171, and a second antenna 220 of the antenna system 200 further includes a second additional branch 172. The first additional branch 171 and the second additional branch 172 may each have a straight-line shape. An open end of the first additional branch 171 and an open end of the second additional branch 172 may extend away from each other. For example, the open end of the first additional branch 171 may extend toward the −X axis, and the open end of the second additional branch 172 may extend toward the +X axis. The first additional branch 171 and the second additional branch 172 are configured to adjust the impedance matching of the first antenna 210 and the second antenna 220, respectively. The length of the first additional branch 171 and the length of the second additional branch 172 are shorter than the length of the first radiation element 140 and the length of the second radiation element 160. A combination of the first radiation element 140 and the first additional branch 171, and a combination of the second radiation element 160 and the second additional branch 172 may each have an F-shape. Other features of the antenna system 200 of FIG. 2 are similar to those of the antenna system 100 of FIG. 1. Accordingly, the two embodiments can achieve similar levels of performance.

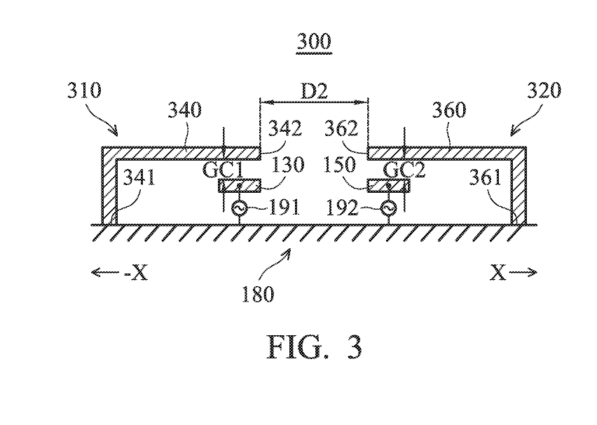

FIG. 3 is a diagram of an antenna system 300 according to an embodiment of the invention. FIG. 3 is similar to FIG. 1. The difference between the two embodiments is that in the antenna system 300, a second end 342 of a first radiation element 340 of a first antenna 310, and a second end 362 of a second radiation element 360 of a second antenna 320 extend toward each other. For example, the second end 342 of the first radiation element 340 may extend toward the +X axis, and the second end 362 of the second radiation element 360 may extend toward the −X axis. Since the first antenna 310 and the second antenna 320 have face-to-face open ends, the spacing D2 between the first antenna 310 and the second antenna 320 should be longer than the spacing D1 between the first antenna 110 and the second antenna 120 of FIG. 1, so as to achieve similar levels of isolation. Other features of the antenna system 300 of FIG. 3 are similar to those of the antenna system 100 of FIG. 1. Accordingly, the two embodiments can achieve similar levels of performance.

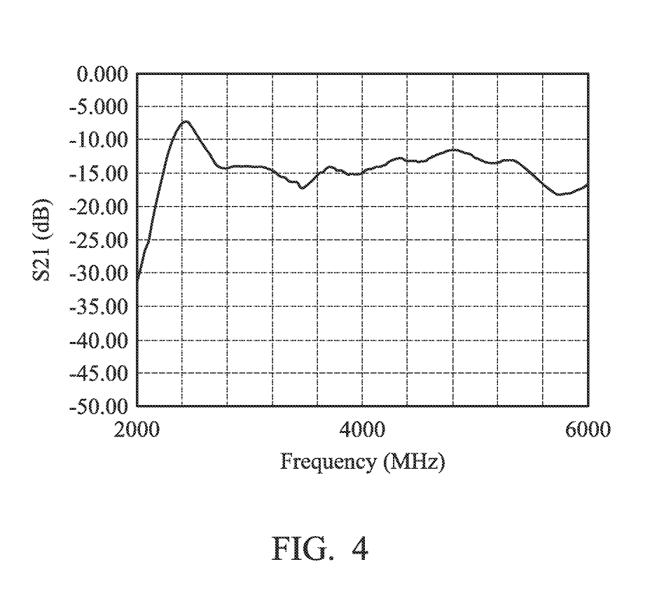

FIG. 4 is a diagram of isolation of a PIFA system. The horizontal axis represents the operating frequency (MHz), and the vertical axis represents the isolation (S21) (dB) between antennas. A conventional PIFA system uses two direct-feed antennas. That is, a respective feeding element of each antenna is directly connected to its respective radiation element. It is assumed that the spacing between the two antennas is D1 and each low-frequency radiation element extends in reverse directions. According to the measurement, the isolation between antennas is apparently worse. The result of FIG. 4 describes that the isolation of the convention PIFA system may be merely −7 dB in low-frequency bands. It represents that the interference between antennas is relatively serious, thereby leading to the poor communication quality of the whole system.

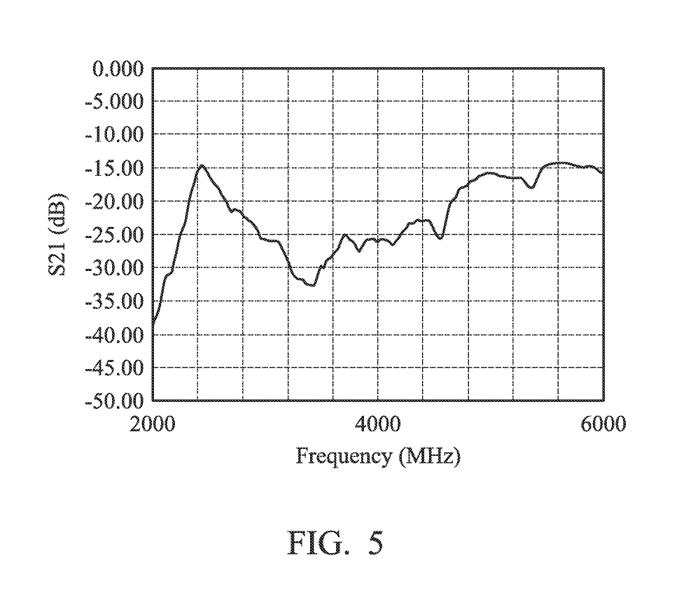

FIG. 5 is a diagram of isolation of an antenna system according to an embodiment of the invention. The horizontal axis represents the operating frequency (MHz), and the vertical axis represents the isolation (S21) (dB) between antennas. In the antenna system of the invention, a first antenna and a second antenna both operate in a first frequency band and a second frequency band. The first frequency band may be substantially from 2400 MHz to 2500 MHz, and the second frequency band may be substantially from 5150 MHz to 5850 MHz. In other words, the invention at least supports the mobile communication frequency band of Wi-Fi and Bluetooth. According to the measurement of FIG. 5, when the antenna system uses at least two coupling-feed antennas described in the embodiments of FIGS. 1 to 3, the isolation between the antennas can achieve −15 dB or better in both the first frequency band and the second frequency band, and it can meet the criteria of general mobile communication. Furthermore, the design of coupling-feed antennas suppresses higher-order resonant modes of low-frequency resonant paths, such that the antenna system of the invention can easily meet the requirements of SAR in every frequency band. For example, the measured SAR may be as indicated in Table I.

TABLE I
Measured SAR (Antenna Gain = −2.95 dBi)

| | SAR measured | SAR measured |
|---|---|---|
| | on the top | on the bottom |
| Conventional PIFA | 1.92 | 1.81 |
| Proposed Antenna System | 1.85 | 0.99 |

Table I shows a comparison of measured SAR. According to the measurement, the invention has significantly lower SAR on the top and bottom than a conventional PIFA does when these antenna systems have the same antenna gain (e.g., antenna gain=−2.95 dBi). More particularly, the proposed antenna system has SAR measured on the bottom which is almost 0.5 times that of the conventional design. As a result, the antenna system of the invention can help to meet the SAR criteria prescribed by law.

Note that the above element sizes, element shapes, and frequency ranges are not limitations of the invention. An antenna designer can fine-tune these settings or values according to different requirements. It should be understood that the antenna system of the invention is not limited to the configurations of FIGS. 1-5. The invention may merely include any one or more features of any one or more embodiments of FIGS. 1-5. In other words, not all of the features displayed in the figures should be implemented in the antenna system of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. An antenna system, comprising:
a first antenna, comprising a first feeding element and a first radiation element, wherein the first feeding element is coupled to a first signal source, a first end of the first radiation element is coupled to a ground region, and a second end of the first radiation element is open and adjacent to the first feeding element; and
a second antenna, comprising a second feeding element and a second radiation element, wherein the second feeding element is coupled to a second signal source, a first end of the second radiation element is coupled to the ground region, and a second end of the second radiation element is open and adjacent to the second feeding element.

2. The antenna system as claimed in claim 1, wherein the first antenna and the second antenna are both coupling-feed antennas, the first radiation element is excited by the first feeding element through mutual coupling, and the second radiation element is excited by the second feeding element through mutual coupling.

3. The antenna system as claimed in claim 2, wherein the coupling-feed antennas are configured to improve isolation and SAR (Specific Absorption Rate) of the antenna system.

4. The antenna system as claimed in claim 1, wherein the second end of the first radiation element and the second end of the second radiation element extend away from each other.

5. The antenna system as claimed in claim 1, wherein the first radiation element and the second radiation element each have an L-shape.

6. The antenna system as claimed in claim 1, wherein the first antenna further comprises a first additional branch, the second antenna further comprises a second additional branch, and the first additional branch and the second additional branch extend away from each other.

7. The antenna system as claimed in claim 6, wherein the first additional branch and the second additional branch each have a straight-line shape.

8. The antenna system as claimed in claim 6, wherein a combination of the first radiation element and the first additional branch, and a combination of the second radiation element and the second additional branch each have an F-shape.

9. The antenna system as claimed in claim 1, wherein the second end of the first radiation element and the second end of the second radiation element extend toward each other.

10. The antenna system as claimed in claim 1, wherein the first antenna and the second antenna both operate in a first frequency band and a second frequency band, the first frequency band is substantially from 2400 MHz to 2500 MHz, and the second frequency band is substantially from 5150 MHz to 5850 MHz.
